(19) United States
(12) Patent Application Publication
(10) Pub. No.: US 2001/0037383 A1
(43) Pub. Date: Nov. 1, 2001

(54) Methods and apparatus for providing high-speed internet access to a device consecutively accessible to different people at different times

(76) Inventor: Leonard E. Sabal, Pt. Pleasant Beach, NJ (US)

Correspondence Address: STRAUB & POKOTYLO, 1 BETHANY ROAD, SUITE 83, BUILDING 6, HAZLET, NJ, 07730, US

(21) Appl. No.: 09/771,405

(22) Filed: Jan. 26, 2001

Related U.S. Application Data
(60) Provisional application No. 60/179,880, filed on Feb. 2, 2000.

(51) Int. Cl. G06F 17/60; G06F 15/173

(52) U.S. Cl. 709/223; 709/225; 705/1

(57) ABSTRACT

Controlling network access through a remote terminal adapter by a customer. Such network access control may be effected by (a) requesting order information from the customer, (b) accepting the requested order information form the customer, (c) verifying credit information provided by the customer, (d) instructing that the remote terminal for network access be enabled, and (e) instructing that the enablement of the remote terminal be terminated at the expiration of a service period

### §0 RELATED APPLICATION

Benefit is claimed, under 35 U.S.C. § 119(e)(1), to the filing date of U.S. Provisional Patent application Ser. No. 60/179,880, entitled “METHODS AND APPARATUS FOR PROVIDING HIGH-SPEED INTERNET ACCESS TO A DEVICE CONSECUTIVELY ACCESSIBLE TO DIFFERENT PEOPLE AT DIFFERENT TIMES”, by Leonard E. Sabal filed on Feb. 2, 2000, for any inventions disclosed in the manner provided by 35 U.S.C. § 112, ¶1. This provisional application is expressly incorporated herein by reference.

### §1. BACKGROUND OF THE INVENTION

### §1.1 FIELD OF THE INVENTION

The present invention concerns providing high-speed Internet access, and in particular concerns providing such high-speed Internet access to devices accessible to a short-term, transient, customer base, such as modems in hotel rooms, dormitory rooms, hospital rooms, time-share condominiums, and any other establishment having terminal adapters accessible to a short-term, transient, customer base, for example.

### §1.2 RELATED ART

Travelers in general, and business travelers in particular will often want to access the Internet during their travels. Currently, such travelers can connect their computing device (such as a lap top computer, information appliance, or other computing device) to a hotel telephone line in their hotel room to establish a connection to the Internet. However, as high speed Internet access (such as via cable modem or digital subscriber line service for example) becomes more prevalent, the present inventors believe that such travelers will not be satisfied by ordinary Internet access via a telephone line, which is typically limited to about 56 Kbps.

Thus, there is a need for methods and apparatus for providing high-speed Internet access to travelers and others who are away from more permanent Internet connections. If hotels could provide such access, such hotels would like to enjoy revenue for the service.

### §2. SUMMARY OF THE INVENTION

Various aspects of the present invention may function to (i) request and accept order information for high-speed Internet access in response to some event, (ii) verify the credit-card data entered by the person or entity ordering the high-speed Internet access, (iii) initiate high speed Internet access service to a modem (or terminal adapter) associated with the person ordering the service, (iv) terminate the high-speed Internet access service, (v) bill for the high speed Internet access service and/or (vi) distribute funds to various parties involved in providing the high-speed Internet access service. Various attributes of the high-speed Internet access may be controlled so that different lengths and levels of service may be provided. In this way, a person could order the length and level of service that best suits their needs at a given price point.

The present invention may be used to permit hotels and other establishments to provide high-speed Internet access on a short-term basis to a transient customer base. Moreover, such establishments need not be involved with billing and collecting for such a service. For both large hotels catering to business travelers, as well as smaller establishments, such as hotels with under 175 rooms for example, the present invention allows local, regional or national capability without requiring additional equipment at each hotel (other than the cable modem or other terminal adapter) or cable head-end. The present invention also permits establishments to enter into agreements to provide a private label Internet access (e.g., “Hilton @Home” High-Speed Internet Access service).

### §3. BRIEF DESCRIPTION OF THE DRAWINGS

FIG. 1 is a high level block diagram of an environment in which the present invention may operate.

FIG. 2 illustrates exemplary fields and records in an exemplary participant properties database.

FIG. 3 illustrates exemplary fields and records in an exemplary temporary account database.

FIG. 4 is a high level flow diagram of an exemplary method for effecting an account initialization process.

FIG. 5 is a high level flow diagram of an exemplary method for effecting a service order process.

FIG. 6 is a high level flow diagram of an exemplary method for effecting a credit card verification process.

FIG. 7 is a high level flow diagram of an exemplary method for effecting a credit card billing process.

FIG. 8 is a high level block diagram of a structure which may be used to effect one or more of the processes of FIG. 1.

FIG. 9 is a communications flow diagram which illustrates an example of an operation of the present invention.

FIG. 10 is a communications flow diagram which illustrates an example of an operation of a billing aspect of the present invention.

### §4. DETAILED DESCRIPTION

The present invention involves novel methods, apparatus and data structures for providing high-speed Internet access. The following description is presented to enable one skilled in the art to make and use the invention, and is provided in the context of particular applications and their requirements. Various modifications to the disclosed embodiments will be apparent to those skilled in the art, and the general principles set forth below may be applied to other embodiments and applications. Thus, the present invention is not intended to be limited to the embodiments shown and the inventors regard their invention as the following disclosed methods, apparatus and data structures and any other patentable subject matter to the extent that they are patentable.

In the following, functions which may be performed by the present invention are introduced in § 4.1. Then, structures, processes, methods and data structures which may be used to effect those functions are described in § 4.2. Finally, an example of how an exemplary system of the present invention may operate is described in § 4.3.

### §4.1 FUNCTIONS

Various aspects of the present invention may function to (i) request and accept order information for high-speed Internet access in response to some event, (ii) verify the credit-card data entered by the person or entity ordering the high-speed Internet access, (iii) initiate high speed Internet access service to a modem (or terminal adapter) associated with the person ordering the service, (iv) terminate the high-speed Internet access service, (v) bill for the high speed Internet access service and (vi) distribute funds to various parties involved in providing the high-speed Internet access service. Various attributes of the high-speed Internet access may be controlled so that different lengths and levels of service may be provided. In this way, a person could order the length and level of service that best suits their needs at a given price point. In § 4.2 below, various exemplary structures, processes, methods and data structures which may be used to effect at least some of these functions are described. An example which illustrates the operation of such an exemplary system is provided in § 4.3 below.

### §4.2 EXEMPLARY STRUCTURES, PROCESSES, METHODS, AND DATA STRUCTURES

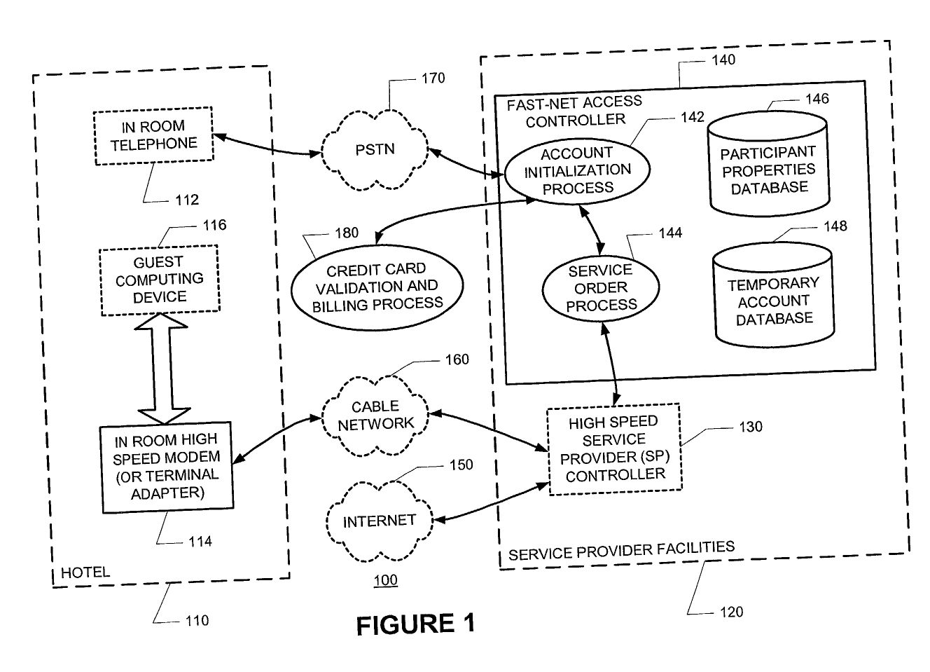

FIG. 1 is a high level block diagram of an environment 100 in which the present invention may operate. As shown, a facility 110, such as a hotel for example, may include a telephone 112, and a high-speed modem (such as a DSL modem, or other high speed terminal adapter, including wireless) 124. A guest's computing device 116, such as a laptop computer for example, may be coupled with the high-speed modem 114. The guest's computing device 116 may include a network interface card (or “NIC”) which may be used to facilitate the coupling with the high-speed modem. The high-speed modem may be coupled with a cable network. At a service provider (such as @HOME or Roadrunner of Time Warner Inc.) facility 120, a high-speed service provider controller 130 may establish a connection between the high-speed modem 114 and the Internet 150, via the cable network 160. The present invention mainly involves the Fast-Net access controller 140, which may be (though needn't be) provided at the service provider facilities as shown in FIG. 1. When a person wishes to access the Internet 150 via the high-speed modem 114, they can use the telephone 112 to call an account initialization process 142, via the public switched telephone network 170. The telephone number may be a local number or a toll free (“800, 888, 877 or other”) number. The account initialization process 142 may use voice prompts to request room number, terminal number, service type, service period, credit card number and/or credit card expiration date information.

Alternatively, the high-speed modem 114 may be provided with start-up software (either preloaded or loaded from a removable storage medium such as a CD-ROM or a diskette for example). This start-up software may be invoked when a person connects their computing device 116 with the high-speed modem 114 and/or when the guest activates their Internet browser (such as Navigator from Netscape or Explorer from Microsoft Corporation for example). In another alternative, initially, Internet access via the high-speed modem 114 may be limited to a server for initializing a temporary Fast-Net Internet access account. Upon credit verification, this server could then command the high-speed service provider controller to enable full Internet access and/or download start-up software.

Once the account initialization process receives the information it has requested, it can use the credit validation and billing process 180 to validate the credit card. Assuming that the credit is approved, the account initialization process 142 may use the service order process 144 to enable the high-speed modem or terminal adapter 114. The account initialization process 142 and/or the service order process 144 may use information stored in the participant properties database 146 to formulate a command to the high-speed service provider controller 130 to enable the high-speed modem or terminal adapter 114. The account initialization process 142 and/or the service order process 144 may also create and use temporary account database 148. Information in this database 148 may be used, for example, to formulate a command to the high-speed service provider controller to enable and/or disable the high-speed modem 114 or terminal adapter and/or to bill usage of the high-speed device.

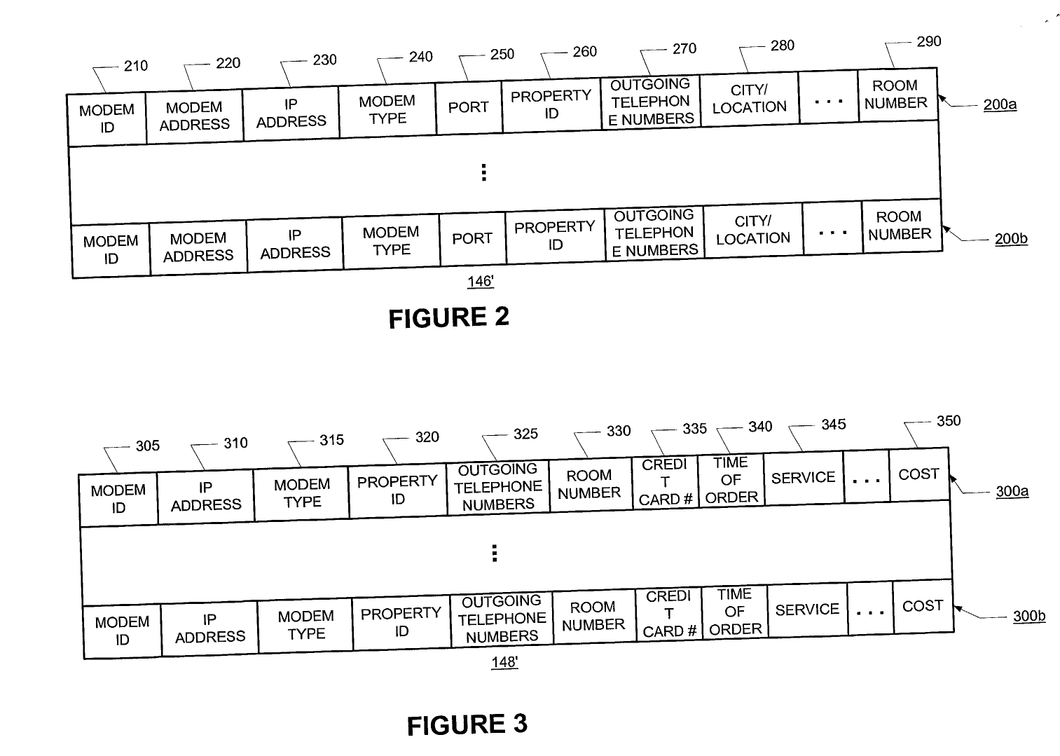

FIG. 2 illustrates exemplary fields and records in an exemplary participant properties database 146′. As shown, each record may include a modem or terminal adapter identifier 210, a modem address 220, an Internet protocol (or IP) address 230, a modem type 240, a port 250, a property (e.g., hotel) identifier 260, a list of outgoing telephone numbers associated with the property (for example, a 150 room hotel may typically have 18-20 telephone lines) 270, a city or location of the property 280 and/or a room number 290. The modem identifier permits the hotel to have a “floating inventory” of modems. Otherwise, a particular modem or terminal adapter could be identified by the room in which it resided, assuming that it would stay in that particular room.

FIG. 3 illustrates exemplary fields and records in an exemplary temporary account database 148′. As shown, each record 300 may include a modem identifier 305, an IP address 310, a modem type 315, a property identifier 320, a list of outgoing telephone numbers 325, a room number 330, the credit card number 335, the time of the order 340, the service (level and/or length) 345 and the cost of the service 350.

Although not shown, a service provider table may be used to provide different service levels and/or options in different places (e.g., geographic regions).

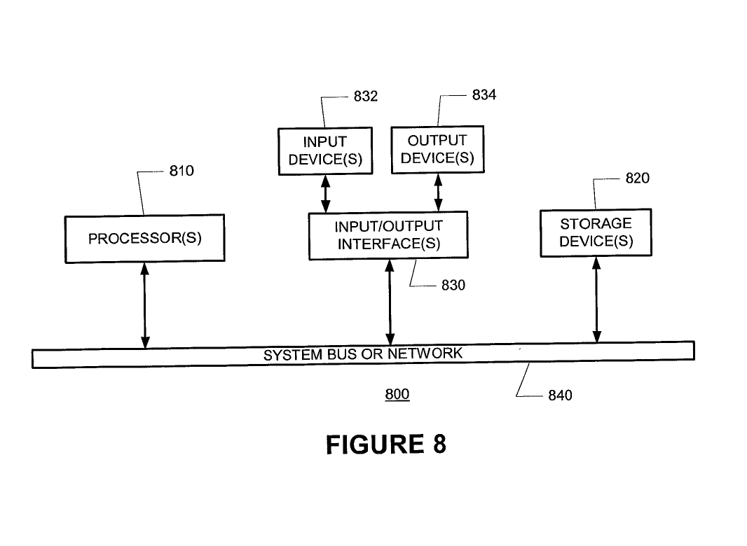

FIG. 8 is a high level block diagram of a structure(s) 800 which may be used to effect one or more of the processes of FIG. 1. Referring to FIG. 8, the functions and processes which may be performed by the present invention may be effected by a processor(s) 810, a storage device(s) 820 (such as RAM, ROM, magnetic, optical, and/or magneto-optic disks, and magnetic tape for example), input/output interfaces 830, an input device(s) 832 (such as a keyboard, a keypad, a pointing device, a microphone, a touch screen and/or a video camera for example), an output device(s) 834 (such as a video monitor, a printer, and/or a speaker(s) for example), and a system bus or network. The processor(s) 810, input/output interface(s) 830, and storage device(s) 820 may communicate with one another via the system bus or network 840. Thus, for example, the functions and processes may be effected by a personal computer or a workstation.

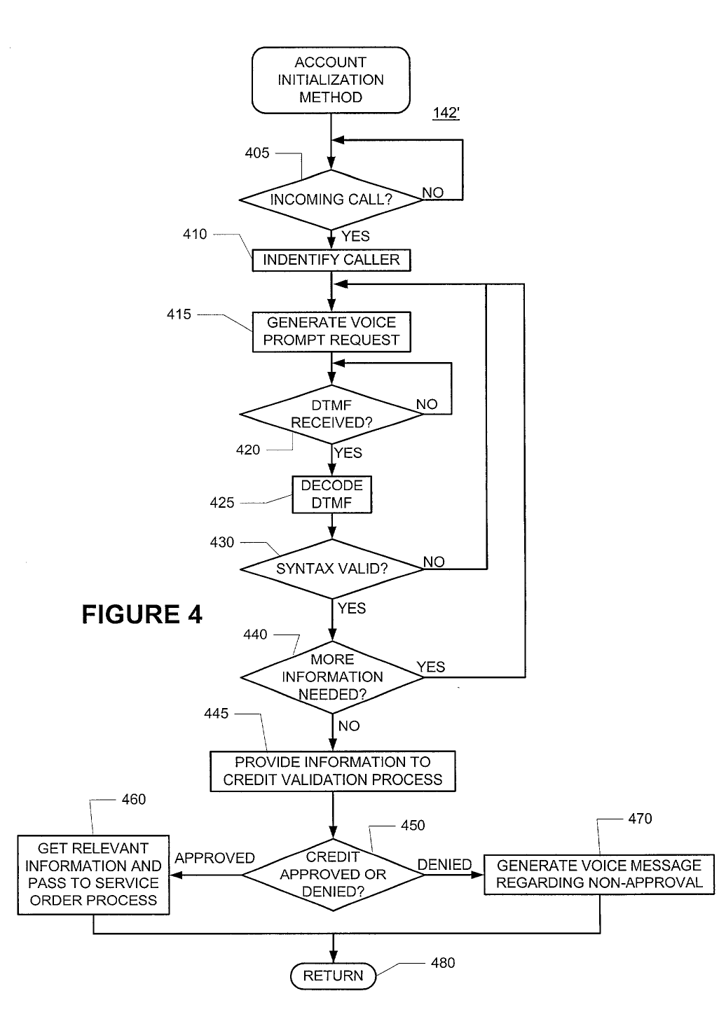

FIG. 4 is a high level flow diagram of an exemplary method 142′ for effecting an account initialization process 142. If an incoming call is received, the caller is identified (such as using caller ID for example) as indicated by blocks 405 and 410. In addition, voice prompts for eliciting information are provided as indicated by block 415. These voice prompts may be, for example:

1. Welcome to the FastNet Internet Access Center.

2. Please enter the 7-digit ID number, found on the front of the modem, now.

3. Please enter your room number, now.

4. FastNet access is available for 1 day at $12.95, for 2 days at $21.95, or for 3 days at 29.95. Service end time is at 12 noon.

5. For FastNet access for 1, 2 or 3 days, use the 1, 2 or 3 key to enter your selection, now.

6. Please enter your VISA or MasterCard number, now.

7. Please enter your credit card expiration date, by month and year, now.

If the order information is entered with a touch tone telephone, a dual tone multi-frequency (or “DTMF”) signal will be received. When such signals are received, they are decoded (for example to numbers) as indicated by blocks 420 and 425. The syntax of the received information may be checked for validity as indicated by block 430. If invalid, the some voice prompt may be repeated so that the person may re-enter the information. If, on the other hand, the syntax is valid, it may be determined whether or not more information is needed as indicated by block 440. If so, additional voice prompt(s) are used to elicit the further information. If no further information is needed, information, such as the credit card number, credit card expiration date and amount for example, may be processed by the credit card validation software as indicated by block 445. A response is then accepted from the credit card validation process. If the credit is approved, the account initialization method 142′ may be used to get relevant information and pass it to the service order process 144, as indicated by blocks 450 and 460. In addition, the following voice messages, for example, may be provided:

1. Your order has been authorized. The charge will be billed directly to your credit card and not to your hotel bill.

2. Thank you for calling the FastNet Internet Access Center.

If, on the other hand, the credit is denied, a voice message regarding the non-approval may be generated and presented to the user via the telephone, as indicated by blocks 450 and 470.

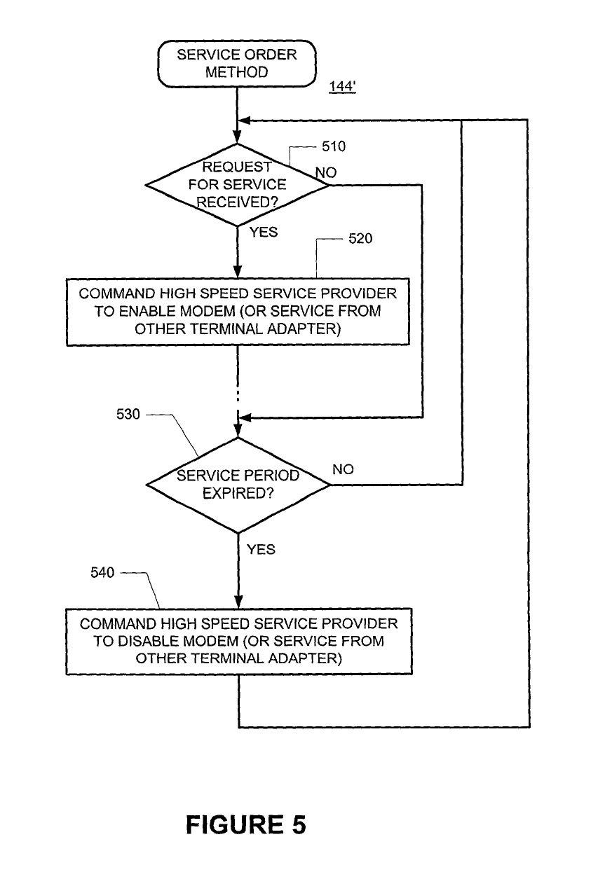

FIG. 5 is a high level flow diagram of an exemplary method 144′ for effecting a service order process 144. If a request for service is received (from the account initialization process for example), the high-speed service provider is commanded to enable the particular modem or terminal adapter, as indicated by blocks 510 and 520. If the service period (e.g., 1, 2, 3 or 7 days) for a particular modem or terminal adapter has expired, the high-speed service provider is commanded to disable the modem or terminal adapter, as indicated by blocks 530 and 540.

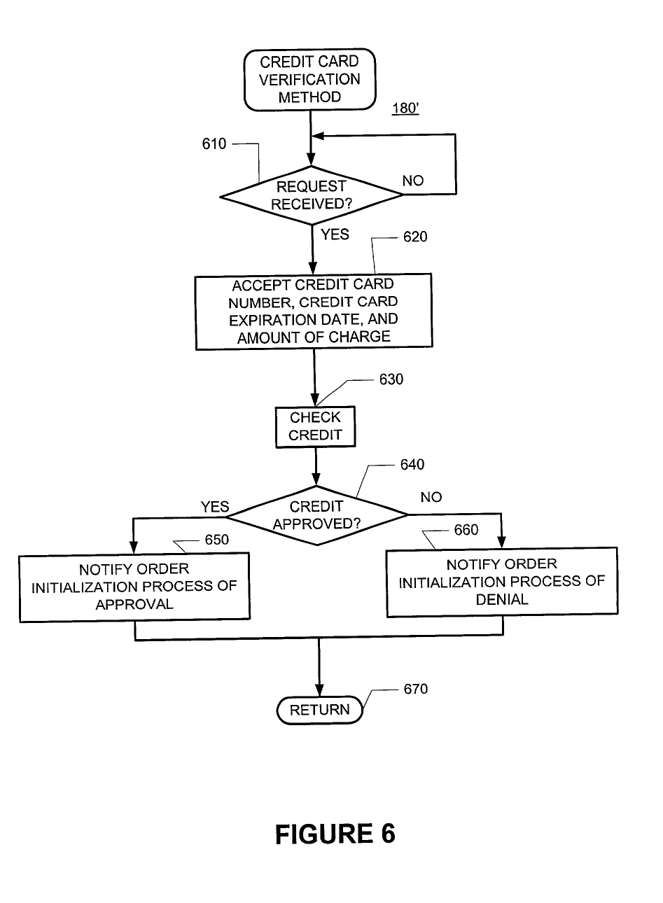

FIG. 6 is a high level flow diagram of an exemplary method 180a′ for effecting a credit card verification process 180. If a request to verify credit is received (from the account initialization process for example), the method 180′ accepts the credit card number, the credit card expiration date and the amount of the charge and checks the credit, as indicated by blocks 610, 620 and 630. If the credit is approved or denied, the requester (e.g., the account initialization process) is so notified, as indicated by blocks 640, 650 and 660. Credit card validation may be accomplished using credit card verification service providers and/or proprietary credit verification techniques.

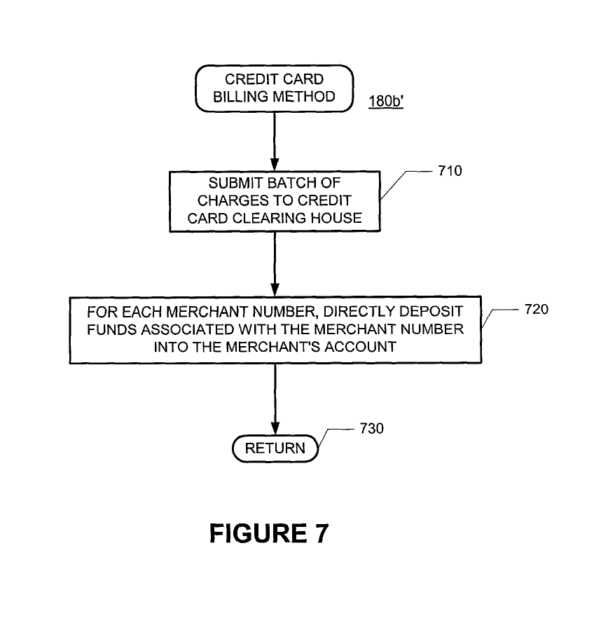

FIG. 7 is a high level flow diagram of an exemplary method 180b′ for effecting a credit card billing process 180. Periodically, or in response to some event, a batch of charge may be submitted to a credit card clearing house, as indicated by block 710. Various relationships between hotels, the Fast-Net access controller operator and the high-speed service provider may exist. Each party may be provided with a merchant number or other identifier. Using a merchant number associated with each charge, the credit card clearing house may directly deposit funds into the merchant's account, as indicated by block 720.

Having described functions, structures, data structures, processes and methods of the present invention, an example illustrating operations of an exemplary embodiment of the present invention is now provided in § 4.3 below.

### § 4.3 OPERATIONS

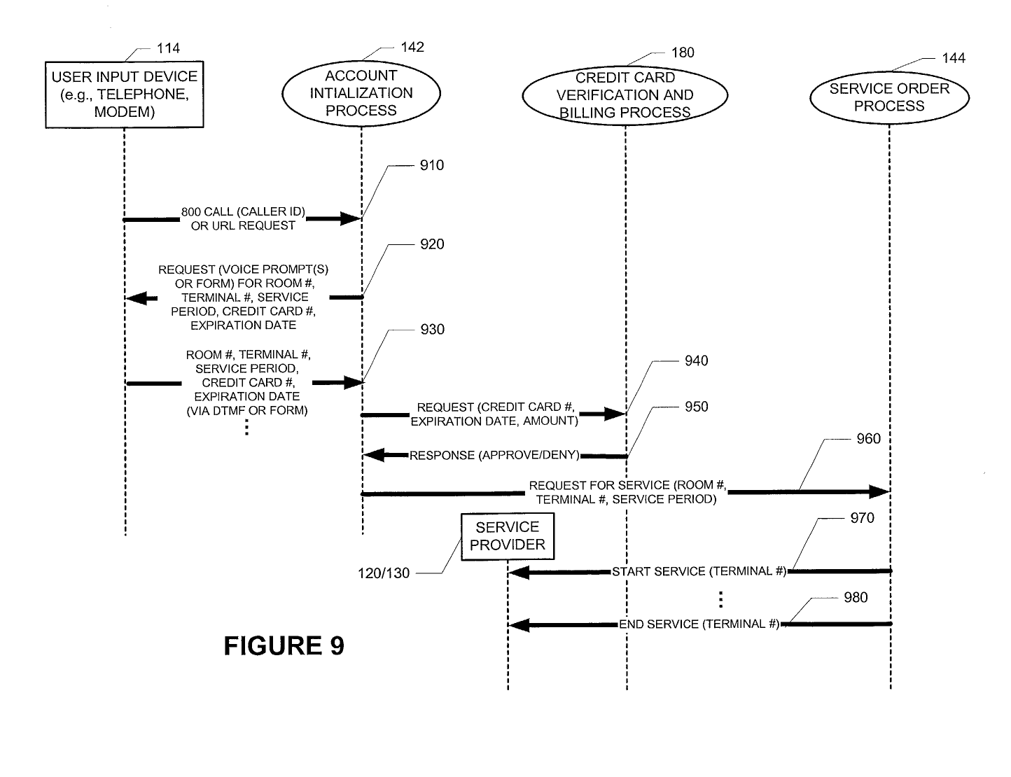

FIG. 9 is a communication flow diagram which illustrates an example of an operation of the present invention. Using a user input device 144, such as a telephone for example, a user can call the account initialization process 142. The call may provide caller ID information. This information may be used, in conjunction with information in the participant properties database, to determine the property from which the user is calling. In response, the account initialization process 142 submits a series of requests 920, for example in the form of voice prompts, to which the user responds 930, for example in the form of DTMF signals. As shown, the room number, terminal (or modem) number, service period, credit card number and expiration date may be requested and provided. In response, the account initialization process 142 may provide the credit card number, expiration date and amount 940 to the credit card verification (and billing) process 180 which sends an “approve” or “deny” response 950 in reply. Assuming that the credit has been approved, the account initialization process can then submit a request 960 for service to the service order process 144. This request 960 may include a room number, a terminal (or modem) number, and a service period and/or level. In response, the service order process 144 may command 970 the (high-speed) service provider (controller) 120/130 to start service to the particular modem or terminal adapter (enable modem). At the end of the service period, the service order process 144 may command 980 the (high-speed) service provider (controller) 120/130 to end the service to the particular modem or terminal adapter (disable modem).

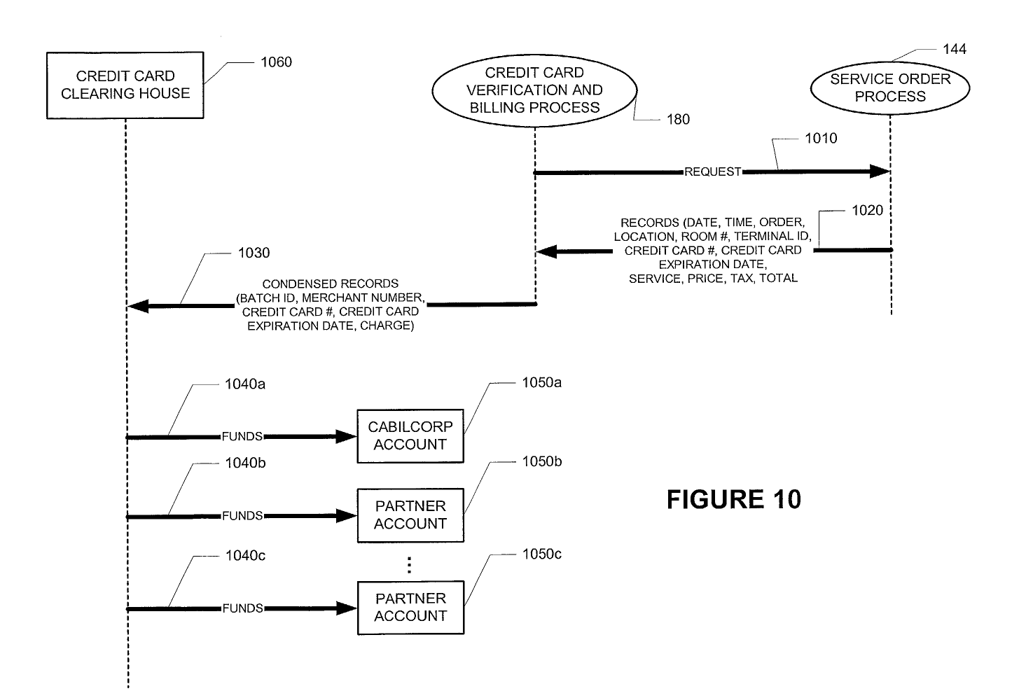

FIG. 10 is a communications flow diagram which illustrates an example of an operation of a billing aspect of the present invention. Periodically, or in response to some event, the credit card (verification and) billing process 180 can submit a request for charges to the service order process 144. In response, the service order process 144 can provide a batch of records 1020 to the credit card billing process 180. Each record may include a date, a time, an order, a location, a room number, a terminal (or modem) identifier, a credit card number, a credit card expiration date, a service (level and/or period), a price, a tax, and a total price. The credit card billing process 180 may condense such records and provide condensed records 1030 to a credit card clearing house 1060. Each condensed record may include a batch identifier, a merchant number, a credit card number, a credit card expiration date and a charge amount. In response, the credit card clearing house 1060 may provide (e.g., wire) funds 1040 to accounts of the various merchants 1050, such as the hotel, the high-speed service provider, and/or the Fast-Net access company, for example. § 4.4 CONCLUSIONS

In view of the foregoing, methods, apparatus and data structures, hotels and other establishments can provide high-speed Internet access on a short-term basis to a transient customer base. Moreover, such establishments need not be involved with billing and collecting for such a service. This opens up this market to all large hotels, as well as smaller establishments, such as hotels with under 175 rooms for example. The present invention allows local, regional or national capability without additional equipment at each hotel (other than the cable modem or other terminal adapter) or cable head-end. The present invention also permits establishments to enter into agreements to provide a private label Internet access (e.g., “Hilton @Home” High-Speed Internet Access service).

What is claimed is:

1. A method for controlling network access through a remote terminal adapter by a customer, the method comprising:
a) initializing an account;
b) verifying credit of the customer; and
c) requesting service via the remote terminal adapter if the credit of the customer is approved.

2. The method of claim 1 wherein the act of initializing an account includes;
i) receiving a connection initiated by the customer;
ii) requesting
A) a room number associated with the remote terminal,
B) an identifier associated with the remote terminal,
C) credit information of the customer, and
D) service period information desired by the customer,
from the customer over the connection; and
iii) accepting the requested information from the customer.

3. The method of claim 2 wherein the act of initializing an account further includes:
iv) storing at least some of the requested information accepted in a temporary account database.

4. A method for controlling network access through a remote terminal adapter by a customer, the method comprising:
a) initializing an account;
b) attempting to verify account information; and
c) requesting service via the remote terminal adapter if the account information is verified.

5. The method of claim 4 wherein the act of initializing an account includes;
i) receiving a connection initiated by the customer;
ii) requesting
A) a room number associated with the remote terminal,
B) an identifier associated with the remote terminal,
C) credit information of the customer, and
D) service period information desired by the customer, from the customer over the connection; and
iii) accepting the requested information from the customer.

6. The method of claim 5 wherein the act of initializing an account further includes;
iv) storing at least some of the requested information accepted in a temporary account database.

7. The method of claim 5 wherein the act of attempting to verify account information includes checking a room number, terminal identifier, and a caller identifier with information in a participant properties database.

8. A machine-readable medium storing information for verifying service requests for use of a network access terminal accessible to a short-term, transient, customer-base, the information including:
a) a first field for storing an identifier associated with the network access terminal;
b) a second field for storing information for identifying a property at which the network access terminal is located;
c) a third field for storing information for identifying a room in which the network access terminal is located.

9. The machine-readable medium of claim 8, wherein the information further includes:
d) a fourth field for storing outgoing telephone numbers associated with the property identified in the second field.

10. The machine-readable medium of claim 8, wherein the information further includes:
d) a fourth field for storing an address of the network access terminal.

11. The machine-readable medium of claim 10, wherein the address is an internet protocol address.

12. A method for controlling network access through a remote terminal adapter by a customer, the method comprising:
a) requesting order information from the customer;
b) accepting the requested order information form the customer;
c) verifying credit information provided by the customer;
d) instructing that the remote terminal for network access be enabled;
e) instructing that the enablement of the remote terminal be terminated at the expiration of a service period.

13. The method of claim 12 further comprising:
f) billing the customer for use of the remote terminal for network access.

14. The method of claim 13 further comprising:
g) distributing funds to at least one of (a) an owner of the remote terminal, and (b) an owner of a property at which the remote terminal is located.
